(19) United States
(12) Patent Application Publication
(10) Pub. No.: US 2009/0138854 A1
(43) Pub. Date: May 28, 2009

(54) SOFTWARE ERROR DETECTION METHOD, SOFTWARE MODULE, DATABASE AND SYSTEM

(76) Inventor: Suresh Mani, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/275,233

(22) Filed: Nov. 21, 2008

(30) Foreign Application Priority Data
Nov. 22, 2007 (IN) 2736/CHE/2007

(51) Int. Cl. G06F 11/36

(52) U.S. Cl. 717/124

(57) ABSTRACT

A method of detecting errors in a software program when executed by a computer, is disclosed. The method comprises the following steps: providing a database comprising a collection of errors occurring in the software program, each error being associated with a location in the software program code triggering the occurrence of the error; accessing the database to retrieve said collection; marking the locations in the software program code that are specified in said collection; monitoring execution of the software program and, if the program execution arrives at one of said marked locations, and generating an output indicating the occurrence of an error. In an embodiment, the generation of the output is conditional and depends the evaluation of a data condition retrieved from said database. The data condition typically comprises parameters relating to a state of the software program at the marked location. This facilitates the detection of data-dependent errors. Other embodiments of the invention include a software module for monitoring the execution of a software program, a database providing the collection of errors and a system including a computer comprising the software module and a database.

### RELATED APPLICATIONS

Benefit is claimed under 35 U.S.C. 119(a)-(d) to Foreign application Ser No. 2736/CHE/2007 entitled “SOFTWARE ERROR DETECTION METHOD, SOFTWARE MODULE, DATABASE AND SYSTEM” by Hewlett-Packard Development Company, L.P., filed on 22 Nov. 2007, which is herein incorporated in its entirety by reference for all purposes.

### BACKGROUND OF THE INVENTION

Software-known problems are problems in computer software programs such as system software or application software, which are known to a software vendor, for instance from after sales testing or feedback from customers bringing such errors to the attention of the vendor. The vendor will typically try to fix such errors in later versions of the computer program. Such problems can be classified as visible and hidden problems. Visible problems display some symptoms of failure such as a software crash or a runtime error. Hidden problems do not show any visible signs of failure, and do not lead to an obvious deviation of intended program behaviour, such as program termination or an output failure. This can make the occurrence of these problems potentially catastrophic because a customer may rely on an erroneous output of the software program because the software program did not show any sign of erroneous behaviour. This makes such errors hard to detect for the customer.

Examples of hidden errors include the execution of an erroneous arithmetic computation by accounting software, the generation of erroneous code by a compiler, the generation of incorrect source code by a migrating tool, and so on.

It can be of paramount importance that the customer becomes aware of the existence of such hidden errors, for instance to encourage the customer to install a later version of the software if available. To this end, the software vendor may employ customer support groups and software developers that spend a considerable amount of time and effort in compiling lists of known software problems for a particular version of a software program to ensure that existing errors in the software become known. This facilitates correction of the errors in software updates as well as customer notification. Such lists may for instance be made available in the product documentation released during the life cycle of the software program, such as on a product support website.

A drawback of such an approach is that it relies on customers checking the product documentation to verify if they are affected by the various problems listed. Moreover, this solution is not effective for complex system software, where it typically is impractical for customers to manually verify if they are affected by a particular listed problem. For instance, in a software program implementing a compiler, the known error may state that the software program may introduce defects in compiled applications when a particular programming language construct is used. It would be a huge overhead for customers to check a complete application source code for the presence of this particular programming language construct.

The exposure of the customer to such hidden errors may be limited by ensuring that the software program regularly checks for the availability of newer releases of the software and immediately prompts the customer when such a release has become available. However, this solution does not inform the customer what types of errors may have been introduced in the output of the software program, which enforces the customer to move to a newer version of software. Moreover, a significant amount of customers is reluctant to install newer versions of software, for instance because of associated cost and/or effort.

Consequently, there exists a need to provide customers with an improved awareness of the presence of errors such as hidden errors in software programs.

### BRIEF DESCRIPTION OF THE DRAWINGS

For a better understanding of the invention, embodiments will now be described, purely by way of example, with reference to the accompanying drawings, in which:

FIG. 1 schematically depicts a software program comprising a hidden error;

FIG. 2 schematically depicts an aspect of a software program sustaining environment according to an embodiment of the present invention;

FIG. 3 schematically depicts another aspect of a software program sustaining environment according to an embodiment of the present invention;

FIG. 4 schematically depicts a flowchart of an embodiment of the method of the present invention; and

FIG. 5 shows an embodiment of a system of the present invention.

### DETAILED DESCRIPTION OF THE INVENTION

It should be understood that the Figures are merely schematic and are not drawn to scale, and that the Figures depict selected embodiments of the invention by way of non-limiting example only. It should also be understood that the same reference numerals are used throughout the Figures to indicate the same or similar parts.

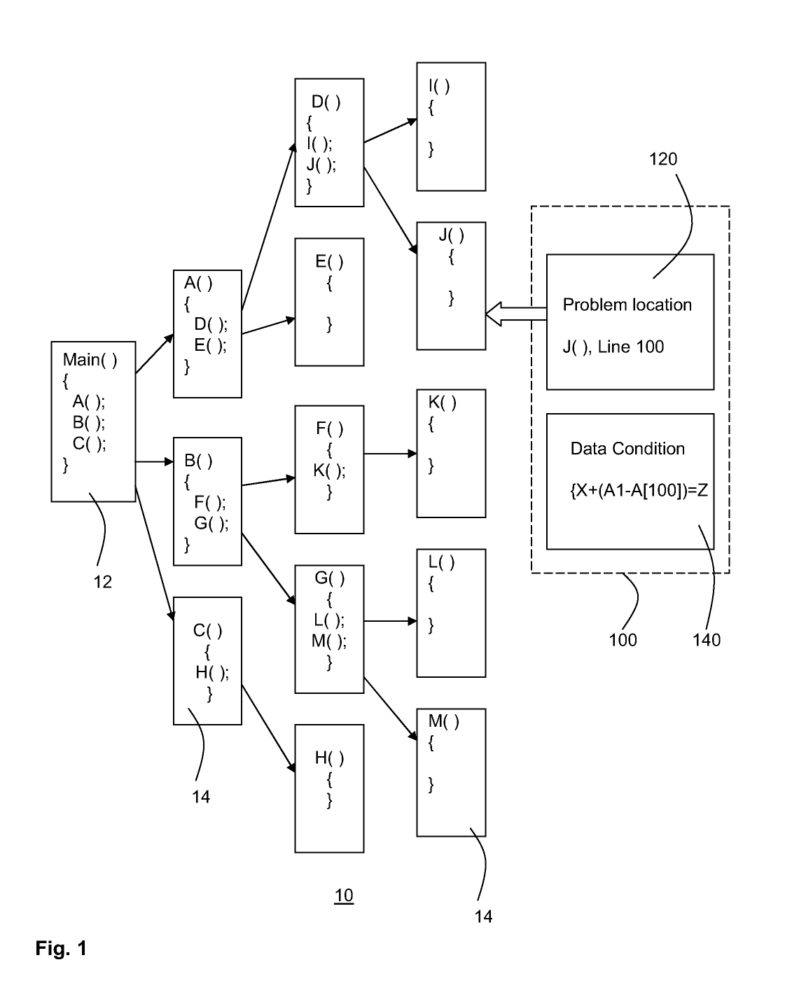

FIG. 1 schematically depicts an arbitrary software program 10. The software program 10 has a main routine 12 and a number of subroutines 14 labeled A to M. During execution of the software program 10, the main routine 12 may call subroutines A, B and C, whereas subroutine A may call subroutines D and E, subroutine D may call subroutines I and J and so on. It will be appreciated that the depicted structure of software program 10 is a mere example of a possible structure of a software program and that many other types of structures are equally feasible.

The software program 10 comprises an error 100 in subroutine J. The error 100 is associated with a location 120 in the software code. The location 120 typically is a point in the software code where a piece of faulty code exists, e.g. ‘line 100 in subroutine J’ in FIG. 1. The error 100 may further be associated with a data condition 140 triggering the occurrence of the error during execution of the software program 10 on a computer, such as the condition X+(A1-A[100])=Z in FIG. 1. X, A1, A[100] and Z are different local and/or global variables in this example. A data condition 140 defines at least a part of the state space of the software program 10, such as the actual values of a collection of variables relevant to the faulty code in location 120.

Alternatively, the error 100 may always occur when the location 120 in the software program code is reached, regardless of the data condition 140. According to an embodiment of the present invention, the error 120 is a hidden error, that is, an error that does not lead to a noticeable failure or disruption of the execution of the software program 10. The occurrence of such an error is likely to lead to an erroneous output of the software program 10, which, if unnoticed, can cause substantial problems to the customer, that is, the user of the software program 10 or the recipient of the erroneous output of the software program 10.

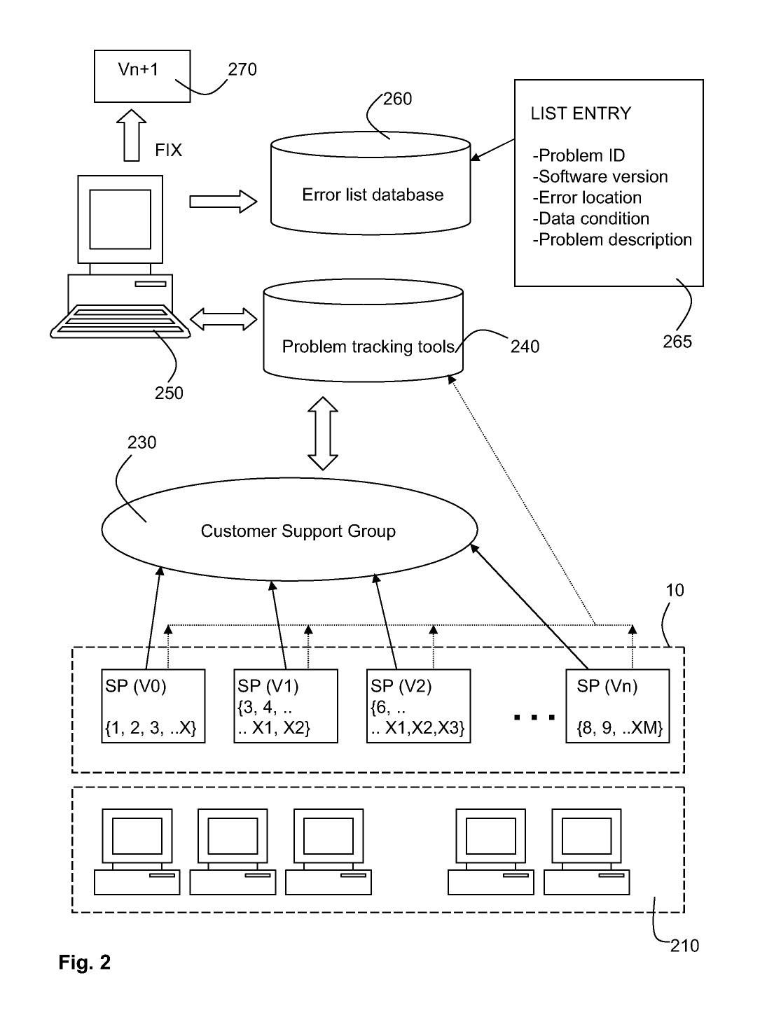

FIG. 2 shows an aspect of a software program sustaining environment according to an embodiment of the present invention. The software program sustaining environment comprises a user community of various versions of the software program 10. The various versions of the software program 10 are labeled V0 to Vn, with each version of the software program 10 having a number of errors, such as errors 1, 2, 3, . . . , X in version V0, errors 3, 4, . . . , X1, X2 in version V1 and so on. FIG. 2 shows multiple versions of the software program 10 by way of non-limiting example only. In an alternative embodiment of the present invention, only a single version of the software program 10 is in existence. The user community 210 may amongst others include customers, quality assurance officers, and software test teams of the software vendor. Upon detection of an error 100 in an actual version ‘Vz’ of the software program 10, the user community 210 reports the occurrence of the error to a customer support group 230 of the software vendor. Alternatively or in addition, the error may be logged with problem tracking tool 240, either by the customer support group 230 in response to the report by the user community 210 or by the user community 210 directly.

The software developers 250 regularly access the problem tracking tool 240 to retrieve the reported software errors 100 The software developers 250 will investigate the code of the appropriate version of the software program 10 to determine the cause of the error 100. This typically includes determining the location 120 in the software program code where the error occurs, and, in case the error occurs under specific data conditions 140, determining the data condition 140 triggering the occurrence of the error 100. The software developer 250 will use this knowledge to rectify the errors in a future release 270 of the software program 10.

According to an embodiment of the present invention, a database 260 is provided with entries 265 in which the errors 100 and their causes are listed by the software developer 250. The database 260 may comprise a collection of entries 265 of errors 100 occurring in a specified version of the software program 10. Each error 100 is typically associated with the location 120 in the software program code that triggers the occurrence of the error, and, where applicable, may further be associated with the data condition 140 that may be required to trigger the occurrence of the error 100.

Each database entry may further comprise a description of the error 100 occurring in the software program 10. The database may comprise multiple collections of errors, with each collection referring to a specific version of the software program 10. Such collections may for instance be organized in lists, although such ordered structures are not essential. The errors associated with a specific version of the software program 10 may for instance also be retrieved from the database 260 by means of a query specifying the version of the software program 10.

For instance, each database entry may have the following attributes:

Problem ID;
Software Version;
Error Location;
Data Condition:
Error Description

wherein the problem ID is an identifier unique to a specific error 100. The error location 120 may be specified in any suitable way. Non-limiting examples of such a specification include:

#Function_name, #Line_number
#Function_name, #*Address
#Function_name, #*Address1 - #Address2
#Stack Trace

such as:

#main #3500
#initialize #230
#main #*0xffabcdaa
#initialize #*0xadbeffe
#main #*0xffabcdaa-#*0xffabcd1f

The above examples specify a location of an error in subroutine main at line 3500, an error in subroutine initialize in line 230, an error in subroutine main at address 0xffabcdaa and an error in subroutine initialize at address 0xadbeffe, as well as a range of addresses 0xffabcdaa to 0xffabcd1f in subroutine main. It will be understood that other formats may be chosen to specify the location 120 of the software code where the error 100 occurs. For instance, the specification of the location 120 may include a number of different lines or addresses, in which case the location specification may be combined with the data condition 140:

{

#Function_name_1, #Line_no_l1; #data condition_d1
#Function_name_2, #Line_no_l2; #data condition_d2
#Function_name_3, #Line_no_l3; #data condition_d3

}

or in case of the location being an address:

{

#Function_name_1, #*address_1; #data condition_d1
#Function_name_2, #*address_2; #data condition_d2
#Function_name_3, #*address_3; #data condition_d3

}

Multiple ranges cay also be specified in this manner:

{

#Function_name_1, #*address_1- #*adress11; #data condition_d1
#Function_name_2, #*address_2 - #*adress12; #data condition_d2
#Function_name_3, #*address_3; #data condition_d3

}

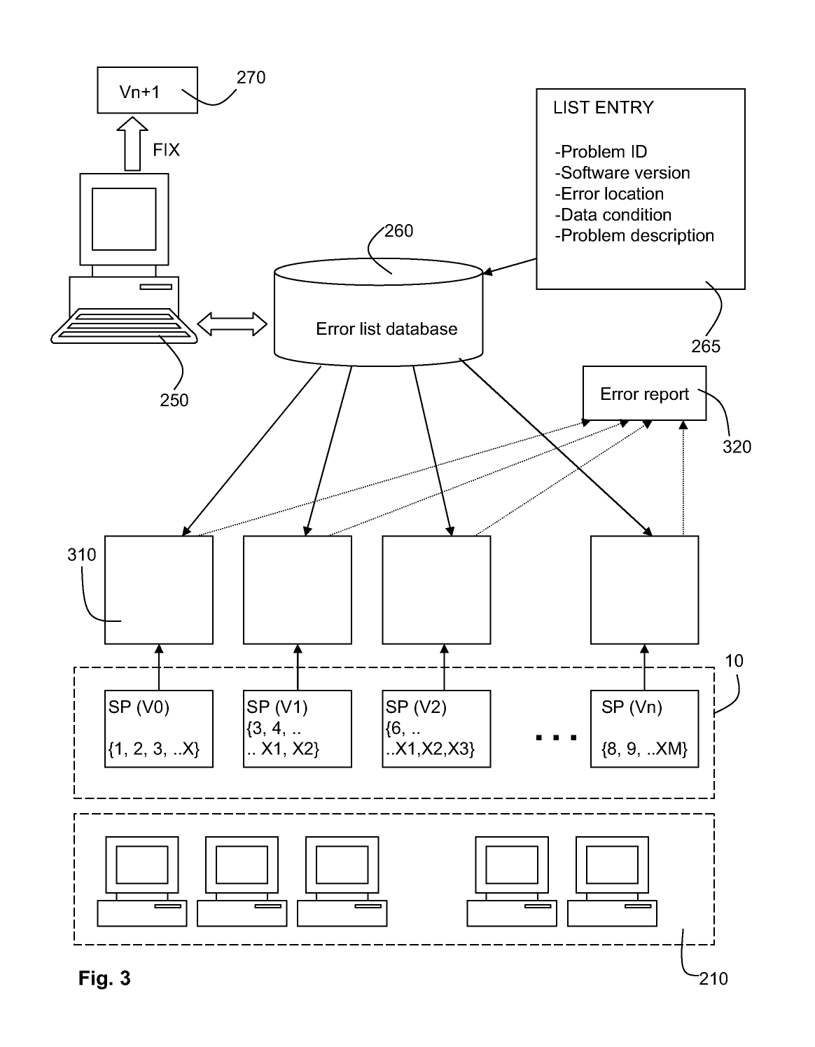

As shown in FIG. 3, the database 260 may be used in conjunction with a software module 310 to inform the user community 210 of the existence of errors such as hidden errors in a particular version of the software program 10.

According to an embodiment of the present invention, the software module 310 has the purpose of monitoring the execution of a particular version of the software program 10 and detecting the occurrence of errors in the execution of the software program 10 using the information stored in the database 260. To this end, the software module 310 is arranged to, when being executed on a computer, access the database 260 to retrieve the collection of errors corresponding to the version of the software program 10 to be monitored, and to mark the locations 120 in the code of the software program 10 that are specified in the respective errors listed in the database 260 for this version of the software program 10.

The software module 310 is further arranged to monitor the execution of the software program 10 on a computer and, if the program execution arrives at one of said marked locations 120, to generate an output indicating the occurrence of an error 100. Such an output may be an additional entry in a log file such as an error report 320, an on-screen warning message to the program user, or any other suitable way of notifying the program user of the occurrence of an error 100 such as a hidden error. In case of one or more errors 100 being triggered by the occurrence of a specific data condition 140 at the location 120, the software module 310 may be further arranged to also retrieve the data condition 140 associated with these errors 100 from the database 260. Such a data condition 140 typically comprises state parameters of the software program 10. In the context of the present invention, state parameters are parameters that define a certain state of a software program such as local variables, global variables, register values, type cast memory addresses, constants and so on. The purpose of including processor registers and memory addresses in the data condition is to facilitate evaluation of data conditions in a highly optimized software program 10, wherein variables may no longer exist because of the removal of symbolic debug information during its compilation.

The software module 310 may be further arranged to evaluate the data condition occurring in the software program 10 when reaching location 120. To this end, the respective values of the state parameters in the data condition 140 are retrieved from the program execution at the marked location. In case the data condition in the software program 10 evaluates to be true, the software module 310 will generate the output indicating the occurrence of the error 100. Alternatively, the output may be generated when the data condition evaluates to be false. Generally speaking, the output may be generated whenever the data condition 140 evaluates to a predefined Boolean value.

The data condition 140 may be listed in the database entry 265 in any suitable format, such as any logical or relational or arithmetic expression permitted by the language in which the software program 10 is written. The logical or arithmetic expression may be expressed in terms of local and static or global data structures present in the software program 10; for instance, assuming that the software program 10 is written in the C programming language, example data conditions include:

| | |
|---|---|
| i) | abc==i*(k+p) &&i==k |
| ii) | temp+10 < i−100 \|\| i >0;and |
| iii) | abc |

Alternatively, the logical or arithmetic expression can be expressed in terms of CPU registers and contents of memory locations. For instance, assuming that the CPU has a number of registers {R1, R2 . . . R32}, example data conditions include:

| | |
|---|---|
| i) | R1>R2 && R1; |
| ii) | ((int) *(0xfffaef) ) > *(R1); |
| iii) | (R1*R2*R3) > (R5 + R6) |

More complex data conditions are equally feasible, as demonstrated by the following non-limiting examples:

i) ((int)*(0xfffaej))>R1), i.e., access the contents of address 0xfffaef as an integer and then compare its contents with the contents of the register R1;

ii) ((long)*(0xfafaej))>R1), i.e., access the contents of address 0xfafaef as long data type and compare it with the contents of register R1;

iii) ((temp+10<i-100)∥(((int)*(0xfffaej)>R1)), which is an example of an expression involving a mixture variables, constants, registers and memory addresses.

Many other variations will be apparent to the skilled person.

Consequently, the user of the software program 10 is made aware of the occurrence of an error such as a hidden error during execution of the software program 10. This reduces the risk of erroneous output of the software program 10 being unnoticed and provides the customer with an additional incentive to install newer versions of the software program 10 in which these errors have been omitted, because the customer has an improved awareness of any errors occurring in the version of the software program 10 used by the customer.

The software module 310 acts as a debugger for the software program 10, in the sense that the software module 310 marks locations, i.e. inserts breakpoints, in the program code of the software program 10 using the entries 265 of the database 260 relating to the correct version of the software program 10 as instructions for identifying the locations 120 for inserting the breakpoints in the program code and for identifying the data conditions 140 for flagging an error in case such a data condition 140 is present. The software module 310 may insert the markers into the code of the software program 310 in any suitable way, such as during start-up of the software program 10. However, unlike conventional debuggers, the software module 310 preferably runs in the background of the software program 310 without displaying prompts and messages other than reporting the occurrence of an error 100 to limit the disruption to the normal operation flow of the software program 10.

The software module 310 may be made available to the customer on a computer-readable data carrier such as a DVD, CD-ROM, memory stick, an internet-accessible server and so on. The software module 310 may be made available on such a carrier together with the software program 10.

The software module 310 may be suitable for use with any version of the software program 10, in which case the software module 310 must be recognizing the version of the software program 10 to retrieve the correct collection of errors 100 from the database 260. Alternatively, the software module 310 may be a version-specific module. In both cases, the software module may be an integral part of the software program 10 or may be an independent entity. The software module 310 may be automatically activated upon start-up of the software program 10.

Alternatively, the software module 310 may be activated by the user of the software program 10, for instance if the user suspects the software program 10 of exhibiting erroneous behavior. User-controlled start-up of the software module 310 may be realized in any suitable way, for example by means of command line start-up, e.g. run software program -mon, by means of starting up the software module 310 using a windows-based menu, or by starting up the software module 310 in a wrapper that subsequently loads the software program 10 and so on.

The software module 310 may access the database 260 via a network such as the internet to retrieve the collection of errors corresponding to the correct version of the software program 10 each time the software module 310 is activated. Alternatively, the software module 310 may store a local copy of the collection of errors 100 and may only access the database 260 to check if the collection of errors 100 has been updated, and only update the local copy if an updated collection of errors is present on the database 260 to reduce the amount of data traffic over the network.

Below some non-limiting examples of example scenarios are given that may be uncovered using the software module 310.

### EXAMPLE 1

### Code Generation Problem in a Compiler (Where the Compiler is the Software Program 10 in this Context)

Problem description. A compiler generated wrong code for some of the arithmetic operators present in the source code compiled. The intermediate code generated by the compiler for addition operation was as follows:
ADD A, B. C
where A, B and C are variables or temporaries. The code generated by the compiler for the above intermediate code is as follows.
ADD r1, r1, r2
where r1, r2, r3 are processor or hardware registers. It can be seen that variables A and B were assigned the same register r1 by the compiler, but in this context they should have been assigned different registers, e.g. ADD r1, r2, r3. This error was tracked down in compiler source code and was found to occur in a particular function named Assign_registers_for_current_eval().
   The function is implemented in the compiler source code as follows:

Assign_registers_for_current_eval(var v1,var v2,var v3)
{
:::
v1->reg= get_free_reg_dest(v1);
:
v2->reg= get_free_reg_src1(v2);
:
v3->reg= get_free_regr_src2(v3); // Line 200
}

The problem with the above code is, as per the design of compilers the calls to function get_free reg_dest() should always succeed the calls to get_free reg_src1() and get_free_reg_src2(). But in this case call to get_free_reg_dest() preceded the calls to get_free_reg_src1() and get_free_reg_src2(). As a result v1→reg and v2→reg were assigned the same processor registers in some instances by the compiler.
Problem definition. The problem defined in terms of error location 120 and data condition 140 is as follows. This particular problem occurs when Line no 200 in Function
Assign_registers_for-current_eval() is reached at compiler runtime and the variables v2→reg or v3→reg have the same value as v1→reg. This problem can be expressed as follows:
#Assign_registers_for_current_eval.#200, #(v1→reg==v2→reg∥v1→reg==v3→reg), where #Assign_registers_for_current_eval.#200 is the error location 120 and #(v1→reg==v2→reg∥v1→reg==v3→reg) is the corresponding data condition 140.

### EXAMPLE 2

### Heap Corruption by an Application TZ (Where Application TZ is the Software Program 10 in this Context)

Problem description. The application TZ crashes because of heap corruption. This problem was traced to a function named Form_name () in TZ, which is implemented in source code as follows:

Char *Form_name (char *name)
{
if ( xyz==abcde)
{
}
else
{
ch=malloc(strlen(name)); //line no 1000
strcpy (ch,name);
}
return ch;
}

The encountered problem is that variable ch should be allocated strlen (name)+1 to accommodate the ‘\0’ character at the end of string name as per C language standard library conventions.
Problem definition. In the above case the error location 120 and data condition 140 would be expressed as follows:
#Form_name#line1000, #1
where #Form_name#line1000 is the error location 120, and #1 is the data condition 140. The notation #1 indicates that data condition is always true or, in other words, that the error 100 is data-independent, i.e. always occurs when line no 1000 in function Form_name is reached at runtime.

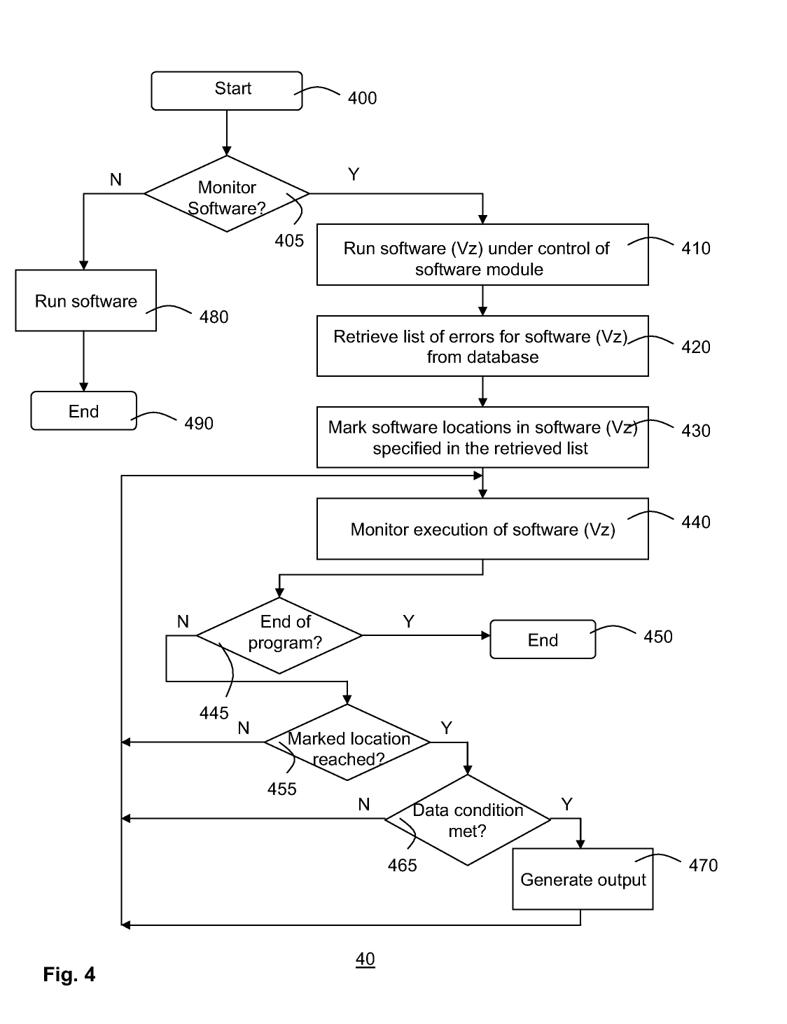

FIG. 4 depicts a flowchart of an embodiment of the method of the present invention. The method is initiated in step 400, after which a check 405 is performed to determine whether or not software monitor 310 should be invoked. If not, the method progresses to step 480 in which the software program 10 is executed without monitoring after which the method terminates in step 490.

If the monitor function is activated, the method progresses to step 410 in which execution of the software program 10 is initiated under control of the software module 310. Next, the database 260, which comprises a collection of errors occurring in the software program 10, with each error being associated with a location in the software program code triggering the occurrence of the error, and which has been provided by the software vendor, is accessed in step 420 to retrieve the database entries 265 corresponding to the collection of errors 100 relevant for the version (Vz) of the software program 10.

The method next progresses to step 430 in which the locations 120 in the software program code that are specified in the collection of errors 100 are marked as previously explained, after which the method progresses to step 440 in which execution of the software program 10 is monitored by the software monitor 310. If the end of the program is reached, as checked in step 445, the method terminates in step 450. Check 445 may be implicit.

If the end of the program 10 has not yet been reached, the method keeps checking the execution of the program in step 455 to determine if a marked location 120 has been reached. If such a marked location is reached, the method may move to step 465 to evaluate the data condition 140 of the software program 10. This includes retrieving the values of the corresponding program state parameters from the program execution at the marked location. In case the data condition evaluates to a predefined Boolean value, i.e. true or false, the method moves to step 470 to generate an output indicating the occurrence of an error 100. Preferably, this output includes a description of the error to help the customer understand the implications of the occurrence of the error. The method subsequently reverts back to step 440 until the end of the program is reached. The method also reverts back to step 440 if checks 455 and 465 are negative.

According to an embodiment of the present invention, step 465 may be omitted in case the error 100 occurring at location 120 is data-independent. In case, step 470 may be executed as soon as the method detects in step 455 that location 120 is reached.

These methods keep the customer informed of known software problems during software usage. These methods use the knowledge of software code path that is executed and the process state information at these paths, to identify occurrences of known software problems incorporated in a version of the software program 10. These methods help persuading customers to upgrade to newer versions of the to software program 10 to ensure that they do not get affected by such known problems.

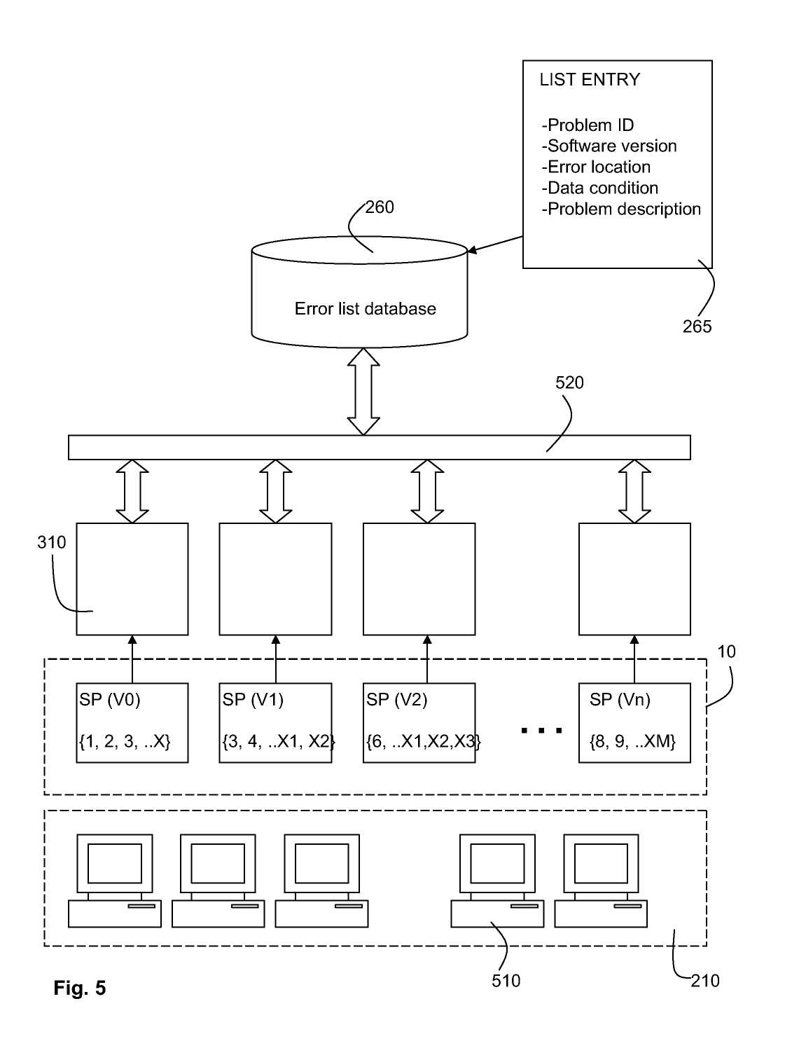

FIG. 5 shows an embodiment of a system of the present invention. A network 520 interconnects one or more computers 510 with the database 260. Each of the computers 510 comprises a version of the software program 10 and a software module 310. The network 520, which, amongst other, may be a LAN network or the internet, enables the software module 310 to access the database 260 so that the software module 310 can retrieve the relevant entries 265, i.e. the entries 265 to form the collection of errors 100 in the version of the software program 10 installed on its computer 510.

We claim:

1. A method of detecting errors in a software program when executed by a computer, comprising:
providing a database comprising a collection of errors occurring in the software program, each error being associated with a location in the software program code triggering the occurrence of the error;
accessing the database to retrieve said collection;
marking the locations in the software program code that are specified in said collection;
monitoring execution of the software program and, if the program execution arrives at one of said marked locations,
generating an output indicating the occurrence of an error.

2. A method as claimed in claim 1, wherein:
each error listed in the database is associated with a combination of a location in the software program code and a data condition triggering the occurrence of the error, said data condition comprising state parameters of the software program;
the step of monitoring execution of the software program further comprises evaluating the data condition using respective values of said state parameters from the program execution at the marked location; and
the step of generating an output comprises generating said output when the data condition evaluates to a predefined Boolean value.

3. A method as claimed in claim 1, wherein the step of marking the locations in the software program code that are specified in said collection comprises marking the locations whilst initiating execution of the software program.

4. A method as claimed in claim 1, wherein the step of marking the locations in the software program code comprises marking locations of a computer memory in which the software program code resides.

5. A method as claimed in claim 1, wherein the database comprises a plurality of collections relating to different versions of the software program, and wherein the step of accessing the database to retrieve said collection comprises retrieving the collection corresponding to the actual version of the software program.

6. A method as claimed in claim 1, wherein the step of marking the locations in the software program code is triggered by a user.

7. A method as claimed in claim 1, wherein the collection further comprises a problem description for each error, and wherein the step of generating an output comprises including the problem description of the error.

8. A method as claimed in claim 1, wherein the step of accessing the database comprises accessing the database via a network.

9. A software module for detecting errors in a further software program when executed by a computer, said software module comprising software program code means adapted to perform, when executed by a computer, the steps of:
accessing a database comprising a collection of errors occurring in the further software program, each error being associated with a location in the further software program code triggering the occurrence of the error;
retrieving said collection from the database;
marking the locations in the further software program code that are specified in said list;
monitoring execution of the further software program and, if the program execution arrives at one of said marked locations,
generating an output indicating the occurrence of an error.

10. A software module as claimed in claim 9, wherein:
each error listed in the database is associated with a combination of a location in the further software program code and a data condition triggering the occurrence of the error; said data condition comprising state parameters of the software program;
the step of monitoring execution of the software program further comprises evaluating the data condition using respective values of said state parameters from the program execution at the marked location; and
the step of generating an output comprises generating said output when the data condition evaluates to a predefined Boolean value.

11. A software module as claimed in claim 9, wherein the step of marking the locations of the further software program code that are specified in said collection is arranged to be executed by the computer during initiation of the execution of the further software program.

12. A software module as claimed in claim 9, wherein the software module is embedded in the further software program.

13. A software module as claimed in claim 9, wherein the software module is embodied on a computer-readable data carrier.

14. A database accessible by a software module as claimed in claim 9, the database comprising a collection of errors occurring in a further software program, each error being associated with a location in the further software program code triggering the occurrence of the error.

15. A database as claimed in claim 14, wherein each error is associated with a combination of a location in the further software program code and a data condition triggering the occurrence of the error.

16. A database as claimed in claim 14, wherein the database comprises a plurality of collections relating to different versions of the further software program.

17. A database as claimed in claim 14, wherein the collection further comprises a problem description for each error.

18. A database as claimed in claim 14, wherein the database is accessible via a network.

19. A system comprising:
a computer comprising a software module and a further software program as claimed in claim 9;
a database as claimed in claim 14; and
a network interconnecting the computer and the database.
